(19) United States
(12) Patent Application Publication
(10) Pub. No.: US 2006/0009111 A1
(43) Pub. Date: Jan. 12, 2006

(54) Method of fabricating cathode structure of field-emission display

(76) Inventors: Kuei-Wen Cheng, Guanyin Township (TW); Chun-Yen Hsiao, Guanyin Township (TW); Jui-Ting Hsu, Guanyin Township (TW)

Correspondence Address: Yi-Wen Tseng, 4331 Stevens Battle Lane, Fairfax, VA, 22033, US

(21) Appl. No.: 10/886,624

(22) Filed: Jul. 9, 2004

(51) Int. Cl. H01J 9/04; H01J 9/12

(52) U.S. Cl. 445/51; 445/50

(57) ABSTRACT

A method of fabricating a cathode structure of a field-emission display. Thick-film technique is employed to apply low-cost silver ink and carbon nanotube material on a substrate. By performing sintering process and polishing process on the low-cost ink and carbon nanotube materials, a first and a second electrode layers can be formed on the substrate with thickness lower than 0.1 microns. Further, the planarity of the first and second electrode layers is also enhanced.

### BACKGROUND OF THE INVENTION

The present invention relates in general to a method of fabricating a cathode structure of a field-emission display, and more particularly, to a method of fabricating a cathode structure using low-cost ink material. In addition, the planarity of the electrode layer and the electron emission source are enhanced by the method as provided, which is advantageous to the post stacking process.

The conventional method for forming the electrode layer and the electron emission layer of a cathode of a field-emission display typically uses thin-film or thick-film technique. The thin-film technique normally provides higher planarity and precision. However, it is more costly compared to the thick-film technique which uses low-cost process such as screen printing or thick-film photolithography for fabricating partial structure of the field-emission display as disclosed in the Taiwanese Patent No. 502395 and 511108, for example.

The thin-film photolithography process such as sputtering or evaporation used to fabricate electrode is not only costly, but is also restricted to a thickness up to tens or hundreds of nanometers only. Under a high voltage, the electrode often flares or open-circuited due to breakdown. In contrast, the electrode material formed by thick-film technique. Therefore, the electrode layer formed by thick-film technique has been widely applied in industry recently.

The screen printing or thick-film photolithography process used for various electrode layers is described as follows. In the example for forming the electrode layer of the cathode, a silver ink is printed and patterned to form the electrode layer, and an electron-emission source layer is formed by printing an ink containing carbon nanotube on the electrode layer. Alternatively, the electron-emission source layer is formed using spray coating or photolithography or electrophoresis or other electrochemical method.

Although screen printing can greatly reduce fabrication cost, such process is restricted to reticulation, knots and emulsion to result in non-uniform planarity. The accumulated error of the stack of the electrode layers can be more than 10 microns. In the example as shown in FIG. 1, although the planarity error can be controlled under 1 micron, the surface of the peripheral first electrode layer (silver electrode) has planarity errors in microns due to the specification of the particles contained in the silver ink. The improvement in planarity of the cathode electrode is thus very limited.

The insufficient planarity uniformity of the first and second electrode layers causes an uneven surface of the dielectric layer formed subsequently, which further results in the following drawbacks.

1. Light scattering occurs during exposure step of photolithography process, such that the fabrication of photoresist is affected.

2. An uneven stack structure is obtained for tripolar or tetrapolar structure. The electric field within a unit area is non-uniform, such that the current density generated by electron beam is no uniform to affect the display quality.

3. As shown in FIG. 1, although a relative even surface of the electron emission source is provided, as the carbon nanotube is a stack formed by deposition, peeling or loose of the carbon nanotube is unavoidable.

### BRIEF SUMMARY OF THE INVENTION

The present invention uses surface polishing technique following formation of cathode of a field-emission display fabricated by thick-film technique, such that the planarity of the cathode is enhanced, and the subsequent process is more easily to perform.

As provided, a thick-film technique is used to apply low-cost silver ink and carbon nanotube on a substrate to form a first electrode layer and a second electrode layer. The silver ink is sintered, and the first and second electrode layers are polished to control a thickness error under 0.1 microns.

### BRIEF DESCRIPTION OF THE DRAWINGS

The above objects and advantages of the present invention will be become more apparent by describing in detail exemplary embodiments thereof with reference to the attached drawings in which:

FIG. 1 is conventional cathode structure of a field-emission display;

FIG. 2 is process flow for fabricating a cathode structure of a field-emission display;

FIG. 3 shows the cathode structure of the field-emission display;

FIG. 4 illustrates the polishing process performed on the cathode structure; and

FIG. 5 shows the polished cathode structure of the field-emission display.

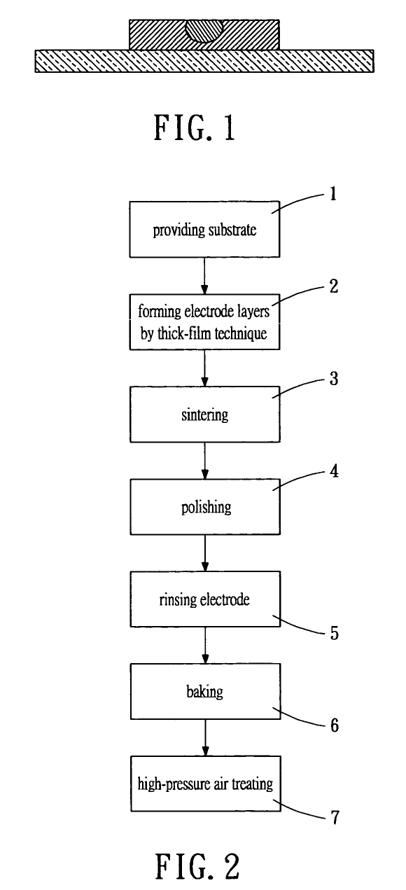

### DETAILED DESCRIPTION OF THE INVENTION

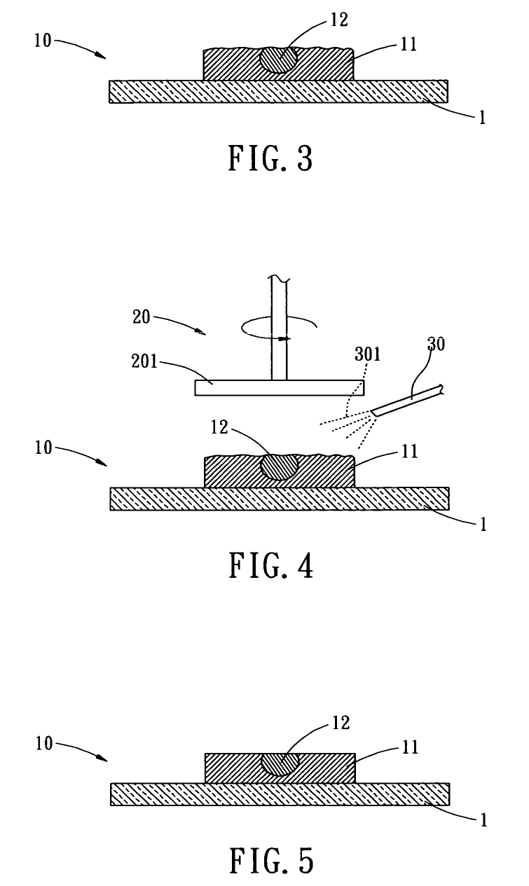

Referring to FIGS. 2 and 3, as provided, the method for fabricating a cathode structure of a field-emission display includes polishing the electrode layers to enhance the planarity thereof.

To fabricate the cathode structure, a substrate 1 such as a glass is provided.

A first electrode layer 11 and a second electrode layer 12 are formed on the substrate 1 by thick-film technique 2. The second electrode layer 12 serving as an electron emission source is preferably fabricated from carbon nanotube, and the first electrode layer 12 is preferably fabricated from low-cost silver ink or silver paste. Preferably, the first 11 and/or the second electrode layer 12 are patterned as desired.

A sintering step 3 is performed with parameters according to specific need. For example, the temperature for the sintering step performed on the first electrode layer 11 is about 400° C. in this embodiment.

A polish technique 4 is performed on the first and second electrode layers 11 and 12, such that the surface planarity error is no more than 0.1 microns.

After the polishing step, the electrode is rinsed by water 5, baked 6, and subjected to a high-pressure air 7 to remove any unwanted residual medium or particles thereon. The cathode structure of the field-emission display is thus formed.

Referring to FIGS. 4 and 5, when the cathode structure 10 is formed, a polishing member 201 of a polisher 20 is used to perform polishing with a high rotation speed of about, 1000 rpm. Meanwhile, polishing medium 301 is sprayed on the first and second electrode layers 11 and 12 via a spray tool 30. The polishing medium 301 includes slurry made of hard metal oxide particles suspension. The metal oxide includes aluminum oxide, zirconium oxide, manganese oxide, or selenium oxide. In this embodiment, solution of selenium oxide suspension is used as the polishing medium. The diameter of the selenium oxide particles is under 1 micron. Therefore, the planarity error can be controlled under 0.1 microns.

The cathode structure fabricated by the above process has the following advantages.

1. The stack of the carbon nanotube for forming the electron emission source is intensified.

2. The surface planarity error of the second electrode layer (the electron emission source) 12 and the first electrode layer 11 is controlled under 0.1 microns.

3. The planarity of the stacked structure, particularly those of tripolar or tetrapolar structure is enhanced, such that the brightness uniformity of the image is improved.

4. The photoresist layer formed in the subsequent process will not be degraded due to light scatter during exposure step.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A method of fabricating a cathode structure of a field-emission display, comprising:
forming a first electrode layer and a second electrode layer on a substrate;
performing sintering process; and
polishing the first and second electrode layers.

2. The method of claim 1, further comprising providing a glass to serve as the substrate.

3. The method of claim 1, further comprising applying silver paste for forming the first electrode layer.

4. The method of claim 1, further comprising applying carbon nanotube for forming the second electrode layer.

5. The method of claim 1, wherein the sintering process is performed at a predetermined temperature.

6. The method of claim 6, wherein the predetermined temperature is about 400° C.

7. The method of claim 1, further comprising polishing the first and second electrode layers with a planarity error lower than about 0.1 microns.

8. The method of claim 1, further comprising using a polishing member to polish the first and second electrode layers.

9. The method of claim 8, wherein the polishing member includes a wool polishing pad.

10. The method of claim 1, further comprising using a spray tool for spraying polishing medium on the first and second electrode layers.

11. The method of claim 10, wherein the polishing medium includes high hardness metal oxide suspension solution.

12. The method of claim 11, wherein the metal oxide includes aluminum oxide, zirconium oxide, manganese oxide or selenium oxide.

13. The method of claim 10, wherein the metal oxide is in the form of particle having a diameter smaller than 1 micron.
